(19) United States
(12) Patent Application Publication
(10) Pub. No.: US 2005/0269540 A1
(43) Pub. Date: Dec. 8, 2005

(54) Bottoms drainage valves designed in particular for enamelled containers

(76) Inventors: Franz-Josef Behler, Wurzburg (DE); Helmut Kunkel, Laufach (DE)

Correspondence Address: FRIEDRICH KUEFFNER, 317 MADISON AVENUE, SUITE 910, NEW YORK, NY, 10017, US

(21) Appl. No.: 10/523,599

(22) PCT Filed: Oct. 8, 2003
(86) PCT No.: PCT/EP03/11128

§ 371 Date: Feb. 4, 2005

(30) Foreign Application Priority Data
Oct. 8, 2002 (DE) 102 46 833.8

(51) Int. Cl. F16K 51/00

(52) U.S. Cl. 251/144

(57) ABSTRACT

The invention concerns a bottoms drainage valve, designed in particular for enamelled containers used in the chemical industry which must satisfy stringent requirements in terms of resistance, easy maintenance and operational safety. Said bottoms drainage valve comprises a flange portion consisting of a cylindrical section forming the valve seat head and capable of being inserted into an annular constriction of the container, as well as a shoulder extending transversely to said cylindrical section and enables the flange portion to be connected to said container. The invention is characterized in that said flange portion is conically tapered towards its upper end and in that a cylindrical sealing module whereof the upper part includes an elastically/plastically deformable reinforced annular sealing zone is interposed in the annular constricted zone, between the flange part and the container wall.

The invention pertains to a bottom drain valve, especially for enameled containers of the chemical industry, on which strict requirements are imposed with respect to resistance, cleanability, and functional reliability, with a flange part consisting of a cylindrical section, which can be inserted into a ring-shaped necked section of the container to form the seat of the valve disk, and of a collar extending transversely thereto, by means of which the flange part can be connected to the container.

Enameled containers for which the bottom drain valve is intended have their fixed place in the chemical industry, especially in the pharmaceutical, biochemical, and genetics areas. The previously mentioned requirements on cleanability can be achieved only by avoiding dead spaces or by sealing off such spaces permanently from the medium-carrying areas of the container and of the valve. Especially the design of the interface between the container and the bottom drain valve has not yet been optimized satisfactorily from this standpoint.

The cylindrical section of the flange part used in conventional bottom drain valves performs not only the task of forming the seat of the valve disk but also the task of sealing off the valve housing against the ring-shaped receptacle in the container. For this purpose, the flange part usually consists of PTFE or a PTFE-coated base body. Because the ring-shaped neck of the container is enameled and because the manufacturing tolerances typical for enameling cannot usually be compensated by effectively adapting the geometry of the flange part, an undefined gap-like dead space is present here, which extends around the circumference. Superimposed on this problem is the possible effects of alternating temperatures on the entire system, which, because of the differences between the coefficients of expansion and the geometric relationships, can also have a negative effect on the width of the gap.

Known attempts to solve this problem make use of systems of circumferential sealing lips; of elastically deformable, ring-shaped inserts in the upper area of the flange part, which form a seal with their flat surfaces; or of tensioned, ring-shaped binding bands (DE 298 08 343 U). DE 298 08 343 U, furthermore, describes a valve seat for the bottom valve of a container with at least one flat, elastic area on the outside surface of the cylindrical section which projects into the container.

The invention is based on the task of improving the bottom drain valve of the type described above in such a way that the ring-shaped dead space or gap can be sealed off against the medium-carrying interior of the container and of the valve without complicated measures such as expandable, deformable, ring-shaped bands, etc.

The bottom drain valve according to the invention in which this task is accomplished is characterized essentially in that the flange part has a conical taper at the upper end and in that a cylindrical sealing module is inserted in the area of the ring-shaped necked section between the flange part and the enameling of the container wall, the upper part of this module being provided with a reinforced, elastically/plastically deformable, ring-shaped sealing area. The functional principle of the inventive design is therefore the use of a two-part solution to seal off permanently the ring-shaped dead space. This two-part solution consists of a sealing module, preferably of PTFE, and the modified flange part. The upper cylindrical part of the sealing module is oversized, and in the first step of the assembly process it is inserted into the container opening. As a result of the surrounding ring-shaped surface of the container opening, the ring-shaped sealing module is pre-deformed in such a way that the entire cylindrical part of the sealing module assumes a conical geometry on the inside.

It has been found to be especially advisable for the sealing module to be reinforced by an elastically/plastically deformable, ring-shaped, replaceable sealing element, around which the thin-walled material at the free end is folded. Sealing elements of various cross-sections can be produced in advance. Depending on the actual design of the enameled container necked section, a seal with the appropriate dimensions can then be selected. As a result, the deformation behavior and thus the radial sealing forces can be optimized.

According to another favorable embodiment, the reinforcement of the sealing module at the free end is formed by a corrugated outlet.

When the flange part is inserted into the premounted sealing module, due to the action of the cone in conjunction with the relative axial movement caused by the assembly-process, the sealing module is subjected to radial elastic/plastic deformation in the ring-shaped sealing area. The geometric form of the free end of the flange part, namely, its conicity, and the form of the sealing area of the sealing module allow the resulting radial forces and tensions to bring about a permanent sealing action.

It has been found that one of the special advantages of the inventive solution is the ease with which the valve can be removed, because, as a result of its conical shape, only a small amount of relative movement in the loosening direction is enough to overcome the radial sealing forces and tensions.

Additional details, advantages, and features of the invention can be derived from the following description, which is based on the attached figures, each of which shows an axial cross section through the flange part of the bottom drain valve, which can be inserted into a ring-shaped necked section of the container, where an elastically/plastically deformable sealing module is present between the flange and the wall of the container:

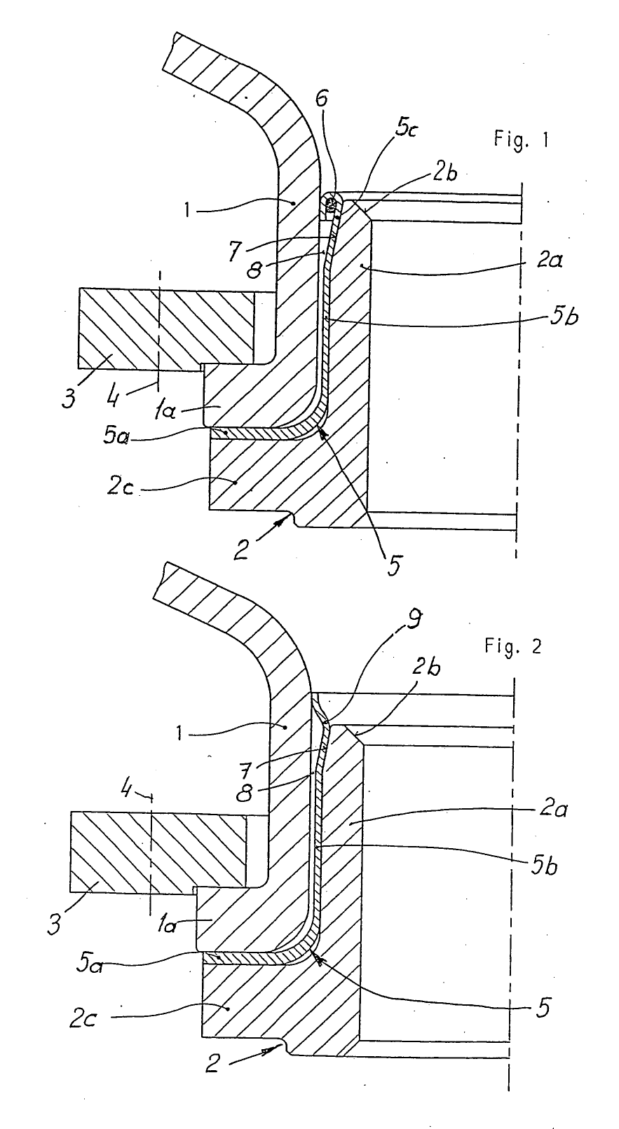

FIG. 1 shows how the sealing module is reinforced by an elastic/plastic, ring-shaped sealing element, which is hammered into the thin-walled material near the free end; and

FIG. 2 shows how the sealing module is reinforced near the free end by a corrugated outlet of the container.

The figures show the bottom area of an enameled container of the type used in the chemical industry; they illustrate in particular the ring-shaped necked section 1 of this container. Strict requirements with respect to resistance, cleanability, and functional reliability are imposed on containers of this type.

The flange part 2 of a bottom drain valve can be inserted into the necked section 1. This flange part consists of a cylindrical section 2a, the upper end 2b of which forms the seat for the valve disk (not shown), and a ring-shaped section 2c, which extends transversely to the cylindrical section 2a. By way of this section 2c, the flange part 2 can be connected to the container, namely, to the flange-like edge 1a of the necked section 1 of the container, by means of a loose flange 3, which rests on the flange edge 1a and which can be clamped to that edge by screwing it along the dash-dot line 4 to a corresponding flange (not shown), which rests on the lower part of the ring-shaped section 2c.

A sealing module 5 is inserted between the flange part 2, i.e., its cylindrical section 2a and ring-shaped section 2c, and the enameled area of the ring-shaped necked section 1 of the container. The flat, circular disk-shaped section 5a of this sealing module 5 is clamped between the flange edge 1a of the necked section 1 and the ring-shaped section 2c of the flange part 2. The upper cylindrical section 5b of the sealing module 5 extending upward from the circular disk-shaped section 5a is provided at the upper free end with an elastically/plastically deformable, ring-shaped sealing area 5c.

In the embodiment according to FIG. 1, this area of the sealing module 5 is formed by an elastically/plastically deformable, ring-shaped sealing element 6, which has been hammered into the thin-walled material of the free end of the sealing module; this sealing element can consist of rubber. In the course of the axially directed insertion of the flange part 2, this upper area of the sealing module 5 is pressed radially against the enameled interior surface of the ring-shaped necked section 1 of the container by the conical taper 7 of the cylindrical section 2a. The permanent elastic/plastic deformation thus ensures that the dead space 8 located under this sealing-area 5c is permanently sealed off, regardless of the thickness of the enamel layer covering the ring-shaped necked section 1 of the container.

In the embodiment according to FIG. 2, the elastically resilient reinforcement, which acts as a sealing area 5c, is formed by a corrugated terminal section, which also provides a seal between the conical taper 7 of the cylindrical section 2a of the flange part 2 and the enameled surface of the ring-shaped necked section 1.

It is advisable for the sealing module to consist of PTFE, which is characterized by its resistance to aggressive chemicals and by its elastic/plastic deformability.

1. Bottom drain valve especially for enameled containers of the chemical industry on which strict requirements are imposed with respect to resistance, cleanability, and functional reliability, with a flange part (2), consisting of a cylindrical section (2a), which can be inserted into a ring-shaped necked section (1) of the container to form the seat of the valve disk, and of a collar (2c) extending transversely to the cylindrical section, by means of which the flange part (2) can be connected to the container, wherein the flange part (2) has a conical taper (7) at the upper end, and in that a cylindrical sealing module (5) is inserted in the area of the ring-shaped necked section (1) between the flange part (2) and the enameling of the container wall, the upper part of this module being provided with a reinforced, elastically/plastically deformable ring-shaped sealing area (5c).

2. Bottom drain valve according to claim 1, wherein the reinforcement of the sealing module (5) is formed by an elastically/plastically deformable, ring-shaped, replaceable sealing element (6), around which the thin-walled material at the free end is folded.

3. Bottom drain valve according to claim 1, wherein the reinforcement of the sealing module (5) in the area of the free end is formed by a corrugated terminal section (9).

4. Bottom drain valve according to claim 1, wherein the sealing module (5) is made of PTFE.
